(19) United States
(12) Patent Application Publication
(10) Pub. No.: US 2009/0323085 A1
(43) Pub. Date: Dec. 31, 2009

(54) Method and system for improving the output quality of image forming devices

(75) Inventors: Michael Joseph Dattilo, Winchester, KY (US); William Roger Steen, Lexington, KY (US); Harold Van de vere Putnam, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc

(21) Appl. No.: 12/215,849

(22) Filed: Jun. 30, 2008

(51) Int. Cl. G06F 3/12

(52) U.S. Cl. 358/1.1

(57) ABSTRACT

The invention describes a method and system for improving the output quality of an image forming device. The method and system enable the image forming device to generate and display notifications to a user. The notifications provide possible suggestions to the user to improve the output quality of the documents to be processed. The image forming device generates the notifications, based on the properties of the document to be processed.

### BACKGROUND

1. Field of the Invention

The present invention relates generally to image forming devices, and more particularly, to a method and system for improving the output quality of the image forming devices.

2. Description of the Related Art

An image forming device produces an image (or copy) of a document containing text, graphics, or a combination thereof. Examples of image forming devices include, but are not limited to, printers and scanners. The image forming device processes a document and produces a copy of it as an output. The output of the image forming device may be a soft copy and/or a hard copy of the document. The soft copy is stored on storage media such as RAM, a hard disk, and the like, whereas the hard copy is printed on paper sheets, vinyl transparencies, and the like.

The present day image forming devices require limited user interaction to produce the desired output. For example, a user can only specify the page margins, the orientation of the document, and the number of copies to be produced. The image forming devices also provide an update to the user on various aspects, such as the status of the device and the job, as well as any malfunction of the device. Based on such updates, the user can either reprint the document or rectify the error. Further, users need to learn the additional functions or any value-added software provided with the device. To understand the functions of such devices, the users need to either read the user manual or see video demonstrations of the device. However, both the methods are tedious and time-consuming. As a result, many additional functions of such image forming devices remain unexplored. Furthermore, the image forming devices do not provide alternative methods for improving the output quality. For example, many users print a colored photograph by using a black-and-white cartridge, although the device may have a colored cartridge. In this event, the device will not alert the user to use the colored cartridge to improve the quality of the photograph.

### SUMMARY OF THE INVENTION

Embodiments of the present invention overcome shortcomings in prior image forming devices and thereby satisfy a need for a system and method to enable image forming devices to improve the output quality. Embodiments of the present invention are capable of providing users with additional functions and making suggestions to a user to improve the output quality of the images formed. The suggestions may include, for example, providing alternative methods or ways for producing the desired image output and also to maximize usage of the additional features or functionalities of the image forming devices, such as colored ink or toner. Further, the image forming devices according to embodiments of the present invention are able to monitor user environments and adapt or modify functions and suggestions accordingly.

Embodiments of the present invention provide a method, a system and a computer program product for improving the output quality of an image forming device. Such an image forming device may include a processing system, a notification system and a display system. The processing system processes one or more documents. The notification system generates one or more notifications for improving the output quality of image forming devices. The notifications are generated based on the properties of the documents identified by the processing system during the processing. The notifications may be then displayed to the user by the display system. In an embodiment of the invention, the notifications include messages for improving the output quality of the image forming device. For example, the notifications include messages to users to change the output format of a document to improve the presentation and readability of the document. In another embodiment of the invention, the notifications can include messages suggesting that the user use the image forming device to print additional information related to the document being printed.

In accordance with embodiments of the present invention, the method for improving the output quality of the image forming device may include identifying one or more rules from a set of rules. The rules may be identified, based on a predefined order. The identified rules may be then evaluated, based on the properties of the documents. The output of the evaluation of the rules may include an identification value, which is compared with a plurality of identification values stored in a plurality of indices. The indices may also store at least one notification that corresponds to each of the plurality of identification values. Thereafter, one or more notifications may be selected from the indices. The selected notifications may have an identification value that corresponds to the identification value obtained from the evaluation of the rules. Finally, the selected notifications are displayed to the user. These notifications may include messages for improving the output quality of the image forming device. The user can then either ignore the notifications or perform actions or follow the steps that correspond to the displayed notifications. For example, if a user prints or intends to print a colored photograph by using a black-and-white cartridge, even if the printing device has a colored cartridge, the device would suggest that the user uses the colored cartridge to improve the quality of the photograph. Thereafter, the user can either ignore the notification or print the photograph by using the colored cartridge.

The method and system according to embodiments of the present invention improve the output quality of image forming devices by providing alternative ways/methods of producing the desired output. The method and system may also provide suggestions for using the image forming device to print additional information related to the document being printed. The method and system may also provide suggestions to effectively utilize resources such as colored ink or toner to improve the quality of the output. Moreover, the system may take inputs from the user's environment and adapt accordingly to produce the desired output. Therefore, the system is user friendly and provides opportunities for increased user interaction.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram illustrating an image forming device, in accordance with an embodiment of the invention;

FIG. 2 is a block diagram illustrating a notification system, in accordance with an embodiment of the invention;

FIG. 3 depicts a flowchart illustrating a method for improving the output quality of the image forming device, in accordance with an embodiment of the invention; and

FIGS. 4(a) and 4(b) depict a flowchart illustrating a method for improving the output quality of the image forming device, in accordance with another embodiment of the invention.

FIGS. 5(a) and 5(b) depict exemplary user interfaces containing the notification for the image forming device, in accordance with an embodiment of the invention.

### DETAILED DESCRIPTION OF DRAWINGS

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

Embodiments of the present invention provide a system, a method and a computer program product for improving the output quality of an image forming device. The term “image” as used herein encompasses any printed or digital form of text, graphics, or a combination thereof. The term, “image forming device” as used herein encompasses devices such as color and black-and-white copiers, color and black-and-white printers, color and black-and-white scanners and so-called “all-in-one devices” that incorporate multiple functions such as scanning, copying, and printing capabilities in one device. Such image forming devices may utilize ink jet, dot matrix, dye sublimation, laser, and any other suitable print formats.

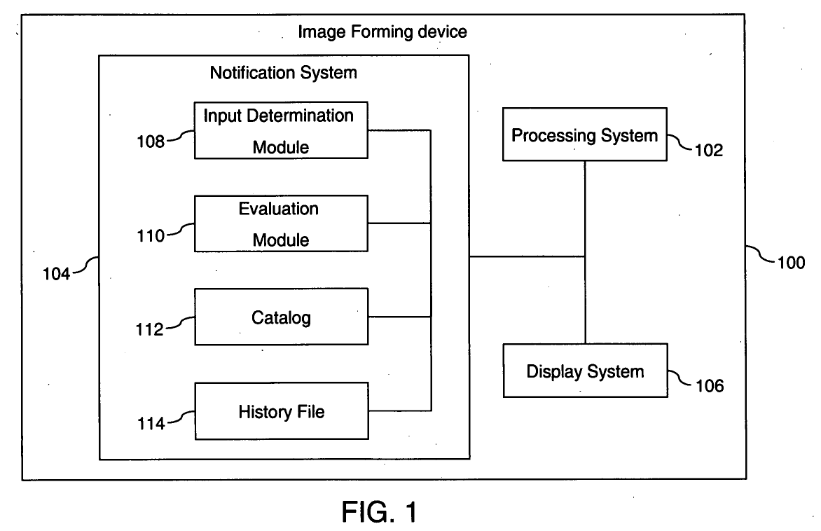

FIG. 1 is a block diagram illustrating an image forming device 100, in accordance with an embodiment of the invention. Image forming device 100 includes a processing system 102, a notification system 104 and a display system 106. Notification system 104 includes an input determination module 108, an evaluation module 110, a catalog 112 and a history file 114.

A user provides one or more documents to image forming device 100 for image formation. Thereafter, processing system 102 receives and processes the documents. In an embodiment of the invention, image forming device 100 can be a printer and processing system 102 can be printer software that receives an input from an application such as Microsoft® Word, Microsoft® PowerPoint®, and the like. The software then schedules, queues and spools printer output. Examples of the software include, but are not limited to, Windows Print Manager and CUPS (Common UNIX® Printing System). Thus, processing system 102 processes the documents and forwards the processed document to a print engine of image forming device 100 for printing (not shown). During the processing of the documents, notification system 104 is capable of generating one or more notifications.

Notification system 104 extracts information from the processed documents. The extracted information is based on the properties of the processed documents. Examples of the properties of the documents include, but are not limited to, the type of document and the number of pages in the document. Based on the properties of the processed documents, notification system 104 generates the notifications. The notifications are used to improve the output quality of image forming device 100. For example, notification system 104 can provide a notification to a user to print students' records that are stored as a Microsoft® Word document, in a Microsoft® Excel format. In an embodiment of the invention, the notifications are used for providing suggestions on using image forming device 100, based on the use of image forming device 100 by a user. For example, if a user is printing a document that is to be presented in a meeting, notification system 104 can generate a notification for the user, suggesting that the names of the participants of the meeting can be printed. These notifications are displayed to the user through display system 106.

Further, notification system 104 uses input determination module 108, evaluation module 110, catalog 112 and history file 114 to generate relevant notifications. Input determination module 108 extracts information from the processed documents. The extracted information is based on the properties of the documents. Examples of the extracted information include, but are not limited to, the type of document, and the size or the number of pages in the document. The extracted information is then forwarded to evaluation module 110. Thereafter, evaluation module 110 uses the extracted information to evaluate one or more rules. In an embodiment of the invention, the rules can be equations that are evaluated by using the information extracted from the documents. Evaluation module 110 evaluates the rules to produce an output, such as an identification value. Examples of the identification values may include ‘ABC’ and ‘XYZ’. The following is an example of a rule expressed in the form of an equation:

Application=“Microsoft Word” AND JobLength>=7, THEN Identification Value=NameTent

The rule above states that an identification value of ‘NameTent’ is generated if the processed document is a Microsoft® Word document and the size of the document is greater than or equal to 7, i.e., the document has more than six pages.

Thereafter, the output of evaluation module 110 is compared with a plurality of indices stored in catalog 112. The indices stored in catalog 112 include a plurality of identification values. Each of the indices also includes at least one notification corresponding to each of the plurality of identification values. In an embodiment of the invention, catalog 112 can be stored on a web server and can store the notifications that are displayed to users across different geographical locations.

After being compared, one or more notifications are selected. The selected notifications are then searched in history file 114, which maintains a record of the notifications displayed in the past. Thereafter, a new notification, i.e., a notification that has not been displayed in the past, is displayed to the user through display system 106. Examples of display system 106 include, but are not limited to, a display or operator panel of image forming device 100. In an embodiment of the invention, display system 106 can be an external display device. Examples of the external display device include, but are not limited to, personal computers, laptops, Personal Digital Assistants (PDAs) and a display, such as an LCD display, integrated with image forming device 100. Thereafter, history file 114 is updated with the displayed notification.

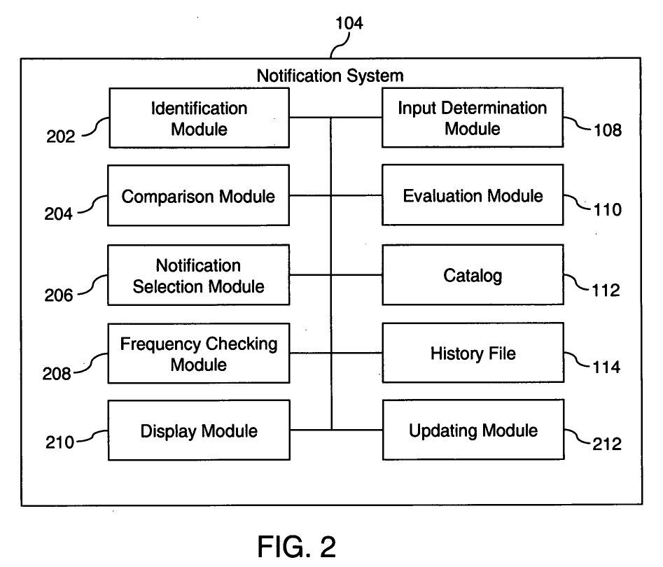

FIG. 2 is a block diagram illustrating notification system 104, in accordance with an embodiment of the invention. Notification system 104 includes input determination module 108, evaluation module 110, catalog 112 history file 114, an identification module 202, a comparison module 204, a notification selection module 206, a frequency checking module 208, a display module 210, and an updating module 212.

Notification system 104 generates one or more notifications to improve the output quality of image forming device 100. Identification module 202 identifies one or more rules from a set of rules stored in a rules file and thereafter, selects one or more rules and forwards the selected rules to evaluation module 110 for evaluation. Evaluation module 110 evaluates the selected rules by using one or more input variables. The input variables are obtained from input determination module 108, which extracts relevant information from the documents. The extracted information is based on the properties of the documents and is stored as input variables. Evaluation module 110 uses the input variables to evaluate the rules and then produces an identification value as an output.

Thereafter, comparison module 204 compares the identification value obtained from evaluation module 110 with a plurality of identification values. The plurality of identification values is stored in a plurality of indices in catalog 112. The indices include at least one notification that corresponds to each of the identification values.

Based on the comparison of the identification values, notification selection module 206 selects one or more notifications from the indices in catalog 112. Notification selection module 206 selects the notification that have an identification value, which corresponds to the identification value obtained from evaluation module 110. Thereafter, frequency checking module 208 checks the frequency of the occurrence of the selected notifications in history file 114.

Subsequently, display module 210 displays the selected notifications to the user. In an embodiment of the invention, the notifications are displayed on an external display device. Examples of the external display device include, but are not limited to, a host-based printer driver user interface. Thereafter, updating module 212 updates history file 114 with the displayed notifications.

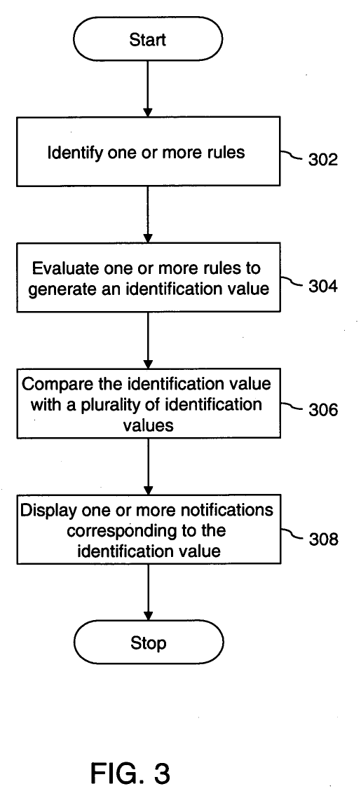

FIG. 3 depicts a flowchart illustrating a method for improving the output quality of image forming device 100, in accordance with an embodiment of the invention. In an embodiment of the invention, the output quality of image forming device 100 may be improved by displaying one or more notifications to a user. In an embodiment of the invention, the notifications include messages that pertain to the status of image forming device 100. For example, the notifications include messages that are related to the status of resources such as ink and the print media used by image forming device 100. In another embodiment of the invention, the notifications include messages that are related to methods for improving the output quality of image forming device 100. For example, the notifications are messages for producing the print output in a different format, messages for producing a colored output, and so on. In yet another embodiment of the invention, the notifications include suggestions on using image forming device 100, based on the use of image forming device 100 by the user. For example, if a user is printing the annual report of a company, one or more notifications can be generated for suggesting the user to print additional information such as the latest news articles relating to the company.

At 302, one or more rules are identified from a set of rules. In an embodiment of the invention, the set of rules is stored in one or more rules files. In an embodiment of the invention, the rules file is stored locally on the user system. In another embodiment of the invention, the rules file can be stored on a web server to be used by users across different geographical locations.

In an embodiment of the invention, rules are an ordered list of expressions or statements. For example, a rule can determine the status of the ink cartridges used by image forming device 100, e.g., a printer. The exemplary rule first determines the type of cartridge being used by the device. Thereafter, the rule determines the level of ink in the cartridge. The exemplary rule is implemented by using the following code:

```
    <?xml version=“1.0” encoding=“iso-8859-1” ?>
  <xsl:stylesheet version=“1.0” xmlns:xsl=“http://www.w3.org/1999/XSL/Transform”>
<xsl:output method=“text” />
  <xsl:template match=“/data”>
  <xsl:if test=“./CartridgeTypeCart1 = ‘Color’”>
  <xsl:choose>
<xsl:when test=“./InkLevelCart1 <=5”>STATUS_CLROUT</xsl:when>
<xsl:when test=“./InkLevelCart1 <=10”>STATUS_CLRLOW</xsl:when>
<xsl:when test=“./InkLevelCart1 <=15”>STATUS_CLRLOW</xsl:when>
      </xsl:choose>
      </xsl:if>
  <xsl:if test=“./CartridgeTypeCart1 = ‘Black’”>
  <xsl:choose>
<xsl:when test=“./InkLevelCart1 <=5”>STATUS_BLKOUT</xsl:when>
<xsl:when test=“./InkLevelCart1 <=10”>STATUS_BLKLOW</xsl:when>
<xsl:when test=“./InkLevelCart1 <=15”>STATUS_BLKLOW</xsl:when>
      </xsl:choose>
      </xsl:if>
  <xsl:if test=“./CartridgeTypeCart1 = ‘Photo’”>
  <xsl:choose>
<xsl:when test=“./InkLevelCart1 <=5”>STATUS_PHOOUT</xsl:when>
<xsl:when test=“./InkLevelCart1 <=10”>STATUS_PHOLOW</xsl:when>
<xsl:when test=“./InkLevelCart1 <=15”>STATUS_PHOLOW</xsl:when>
      </xsl:choose>
      </xsl:if>
        </xsl:template>
      </xsl:stylesheet>
```

The rules are stored in the rules file in an order. One or more rules are identified from the rules file, based on a predefined order. In an embodiment of the invention, the rules are identified from the rules file, based on the order defined by a rules index. In another embodiment of the present invention, the rules index stores the set of rules, the predefined order in which the rules need to be evaluated, and the one or more input variables required to evaluate the rules. The rules index may also store a flag corresponding to each of the rules. The flag determines whether the notification generated by the corresponding rule should be added to history file 114. In yet another embodiment of the invention, the rules index stores a sequential list of the file names of the one or more rules files containing the set of rules.

Further at 304, the identified rules are evaluated, based on the properties of the documents. The identified rules are evaluated in a definite order determined by the rules index. An exemplary rules index can be implemented by using the following code:

```
    <?xml version=“1.0” encoding=“iso-8859-1” ?>
  <rules>
<rule>
<xsl_file>InkStatus.xsl</xsl_file>
<data>InkLevelCart1</data>
<data>InkLevelCart2</data>
<data>CartridgeTypeCart1</data>
<data>CartridgeTypeCart2</data>
<data>CartAuthenticityCart1</data>
<data>CartAuthenticityCart2</data>
      </rule>
  <rule>
<xsl_file>RecycleInk.xsl</xsl_file>
<data>InkLevelCart1</data>
<data>InkLevelPrevJobCart1</data>
<data>InkLevelCart2</data>
<data>InkLevelPrevJobCart2</data>
      </rule>
<rule>
<xsl_file>InkLevels.xsl</xsl_file>
<data>InkLevelCart1</data>
<data>InkLevelPrevJobCart1</data>
<data>InkLevelCart2</data>
<data>InkLevelPrevJobCart2</data>
<data>CartridgeTypeCart1</data>
<data>CartridgeTypeCart2</data>
<data>CartAuthenticityCart1</data>
<data>CartAuthenticityCart2</data>
      </rule>
  <rule>
<xsl_file>GetKCM.xsl</xsl_file>
<data>JobName</data>
<data>CartridgeTypeCart1</data>
<data>CartridgeTypeCart2</data>
<data>DaysSinceShowedNonInkBB</data>
<history>true</history>
      </rule>
  <rule>
<xsl_file>GetK.xsl</xsl_file>
<data>JobName</data>
<data>CartridgeTypeCart1</data>
<data>CartridgeTypeCart2</data>
<data>DaysSinceShowedNonInkBB</data>
<history>true</history>
      </rule>
      </rules>
```

The exemplary rules index stores the rules related to the ink or toner used by a printer in a particular order. The evaluation of the rules produces an identification value, which can be one or more alphabets, a numeric value, or a combination thereof, i.e., the alphanumeric value. In another embodiment of the present invention, the identification value can include special symbols such as #, $, ̂, %, and the like.

Thereafter, at 306, the identification value obtained from the evaluation of the rules is compared to a plurality of identification values. The identification values are stored in a catalog such as catalog 112 with the corresponding notifications. Each of the identification values is associated with one or more notifications. The identification value obtained from the evaluation of the rules is matched with the identification values stored in catalog 112. Subsequently, at 308, one or more notifications are displayed to the user. The displayed notifications are selected from catalog 112. The notifications selected from catalog 112 have an identification value similar to the identification value obtained from the evaluation of rules. The displayed notifications provide one or more methods for improving the output quality of image forming device 100.

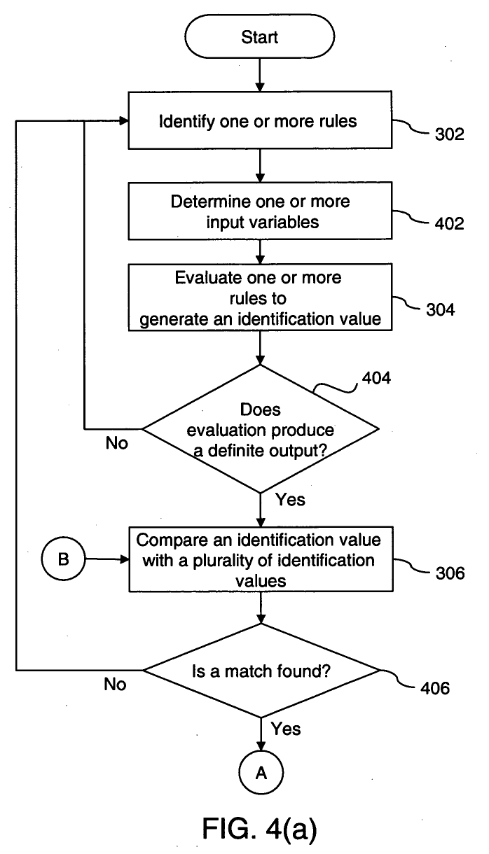

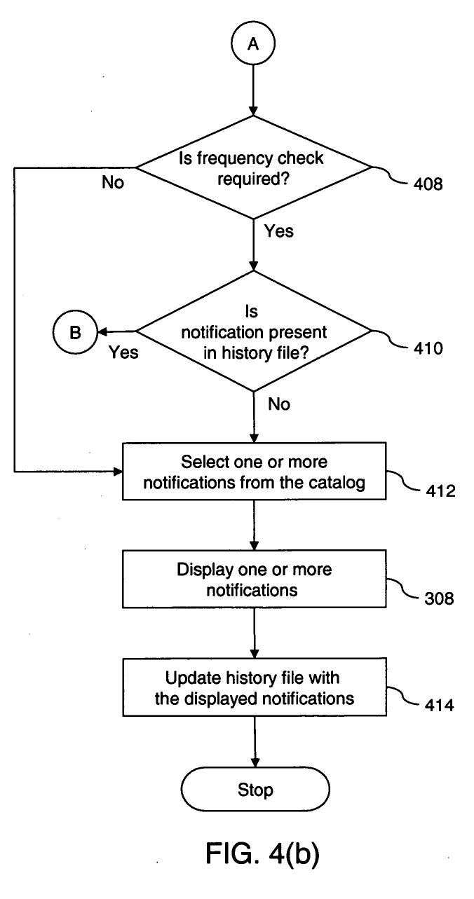

FIGS. 4(a) and 4(b) depict a flowchart illustrating a method for improving output quality of image forming device 100, in accordance with another embodiment of the invention. At 302, one or more rules are identified from the set of rules as explained in conjunction with FIG. 3. In an embodiment of the invention, rules are equations that require one or more input variables for evaluation. The following is an example of a rule:

Application=“Microsoft PowerPoint” AND JobLength>=“3” THEN Identification Value=NameTent

The exemplary rule states that if the type of the document being processed is Microsoft® PowerPoint® and the length (size) of the document is greater than or equal to three pages, an identification value of ‘NameTent’ is generated. In the exemplary rule, ‘application’ and ‘job length’ are two input variables required for the evaluation of the rules.

Further, at 402, one or more input variables are determined, based on the properties of the documents. For example, the type of document and the size of the document can be used as input variables for the rules. In an embodiment of the invention, the input variables are also selected from the user environment. For example, the current date (month, date, year, day of week), language, country code and operating system can be used as input variables. In another embodiment of the invention, the input variables can be based on the properties of image forming device 100. For example, the ink levels or the type of cartridge can be used as input variables. The input variables are used to evaluate the rules.

Subsequently, at 304, the identified rules are evaluated by using the input variables. The rules are evaluated in a predefined order, as explained in conjunction with FIG. 3. The evaluation of the rules produces an identification value as an output. For example, the following rule is applied to a Microsoft® Word document of seven pages:

Application=“Microsoft Word” AND JobLength>=“5” THEN Identification Value=NameTent1

The rule given above is evaluated by using the ‘application type’ or the type, length or size of the document. On evaluating the rule above, by using the set of input variables, an identification value of ‘NameTent1’ is generated. In an embodiment of the invention, the rules are tokenized into a regular expression for evaluation.

Thereafter, at 404, it is determined whether the evaluation of the rules produces a definite output. In an embodiment of the invention, based upon information extracted from the processed documents, the evaluation of the rules may generate an identification value as an output, generate multiple identification values as an output, decide not to produce an output or produce a null value. Therefore, at 404, a check is performed to ensure that the evaluation of the rules produces a definite output. If the output of the evaluation of the rules is not determined, i.e., the output is a null value or the output signifies a failure, a new set of one or more rules are identified at 302.

If the output of the evaluation at 404 is a definite output, the identification value obtained from the evaluation of rules is then compared with a plurality of identification values at 306. In an embodiment of the invention, the identification value is compared to identify a similar identification value. The multiple identification values are stored in catalog 112. Catalog 112 stores a plurality of indices. Each of the indices includes at least one notification that corresponds to each of the identification values. In an embodiment of the invention, catalog 112 stores catalog IDs that correspond to each of the notifications. Each index in catalog 112 includes a unique catalog ID that corresponds to each of the notifications. Further, each of the identification values corresponds to one or more catalog ID. In another embodiment of the invention, catalog 112 can also store the actions or steps to be followed when the user provides feedback on the notifications or the actions performed after the implementation of the notifications. For example, the actions can include launching an application or a browser with a URL. In yet another embodiment of the invention, the file names and/or other descriptors of the content, such as the images and sounds in the notifications, are stored in catalog 112. An exemplary catalog can be implemented by using the following code:

```
  <?xml version=“1.0” encoding=“iso-8859-1” ?>
<billboards>
  <billboard>
<id>DEFAULT</id>
<type>STANDARD</type>
<fileName>defaultbb.xml</fileName>
  <categories>
<category>DEFAULT</category>
      </categories>
  <actions>
<action>https://surveys.lexmark.com/survey/s?s=9519</action>
      </actions>
<navigate>true</navigate>
      </billboard>
  <billboard>
<id>INK_STATUS</id>
<type>INK_STATUS</type>
<fileName>inkstatusbb.xml</fileName>
<categories>
<category>INK</category>
      </categories>
  <actions>
        <action>\hat{ }_BaseUrl_\hat{ }/MD/?func=supplies&lang=\hat{ }_LanguageCode_\hat{ }&ctry=
        \hat{ }_CountryCode_\hat{ }&os=\hat{ }_OsCode_\hat{ }&src=1&PSI=\hat{ }_PSI_\hat{ }\hat{ }_PartnerCode_\hat{ }</action>
      </actions>
<navigate>true</navigate>
      </billboard>
  <billboard>
<id>RECYCLEINK</id>
<type>STANDARD</type>
<fileName>recycleinkbb.xml</fileName>
  <categories>
<category>STANDARD</category>
      </categories>
  <actions>
        <action>\hat{ }_BaseUrl_\hat{ }/MD/?func=recycle&lang=\hat{ }_LanguageCode_\hat{ }&ctry=
        \hat{ }_CountryCode_\hat{ }&os=\hat{ }_OsCode_\hat{ }&src=1&PSI=\hat{ }_PSI_\hat{ }\hat{ }_PartnerCode_\hat{ }</action>
      </actions>
<navigate>true</navigate>
<restoreGui>true</restoreGui>
      </billboard>
```

The exemplary catalog includes notifications, also referred to as billboards. The catalog also stores catalog ids, also referred to as billboard descriptors, corresponding to each of the notifications. Each notification has a unique catalog id. Further, the catalog stores the type of the notifications such as default, warning and so forth, the category such as standard, ink and the so forth, and the actions performed after the implementation of the notifications. Each catalog ID can have one or more categories assigned to it.

Subsequently, at 406, it is checked to determine whether a match for the identification value has been found in catalog 112. If the identification value obtained from the evaluation does not match any of the multiple identification values stored in catalog 112, the process moves to 302 to identify a new set of one or more rules. However, if the identification value matches one or more identification values in catalog 112, the process moves to 408. In an embodiment of the invention, if the identification value obtained from 304 is identical to an identification value, the catalog IDs (stored in catalog 112) corresponding to the identification value is retrieved. In another embodiment of the invention, if the identification value obtained from 304 is identical to more than one identification values, a plurality of catalog IDs corresponding to the identification value is retrieved from catalog 112.

Thereafter, at 408, it is checked to determine whether a user wants to perform a frequency check. A frequency check is the process of searching the notifications corresponding to the identification value obtained from 304 in history file 114. History file 114 maintains a record of the notifications displayed to the user in the past. In an embodiment of the invention, history file 114 contains catalog IDs corresponding to each of the notifications displayed in the past. If the user requests the frequency check, the process moves to 410. However, if the user does not require the frequency check, the process moves to 412. It is understood that the user may request that a frequency check be performed prior to image forming device 100 processing the document, and that the user request may even be stored in memory in image forming device 100 for access by image forming device 100 whenever a document is processed.

Further, at 410, it is determined whether the notifications corresponding to the identification value are present in history file 114 when the frequency check is performed. In an embodiment of the invention, a user can specify the number of notifications to be searched in history file 114. For example, a user can specify that only the last five notifications displayed are searched. In another embodiment of the invention, history file 114 is searched for a predefined default number of notifications. If the notification is present in history file 114, the process moves to 306, to determine a new notification corresponding to the identification value obtained from 304. In an embodiment of the invention, the catalog ID of the notification corresponding to the identification value obtained from 304 is searched in history file 114. If the catalog ID of the notification is present in history file 114, the process moves to 306 to determine the catalog ID of a new notification corresponding to the identification value obtained from 304.

In various embodiments of the invention, specific notifications are selected, irrespective of their frequency in history file 114. The specific notifications include warning messages related to the status of image forming device 100. For example, messages highlighting low ink levels are always selected, irrespective of their occurrence in the past.

In another embodiment of the invention, a default notification is selected if all the selected notifications, such as notifications with identification values corresponding to the identification value obtained from 304, have been displayed in the past. For example, the default notification contains a logo or symbol of the company manufacturing image forming device 100 being used.

However, if the notification is not present in history file 114, the notification corresponding to the identification value obtained from 406 is selected from catalog 112 at 412. In an embodiment of the invention, a plurality of notifications corresponding to the identification value obtained from 406 is selected from catalog 112.

Thereafter, at 308, the selected notifications are displayed for the user. In an embodiment of the invention, the notifications, also referred to as billboards, are displayed to a user in a text format, a graphical format, or a combination thereof.

Finally, at 414, history file 114 is updated with the displayed notifications. Therefore, at 414, an entry of the displayed notifications is made in history file 114. In an embodiment of the invention, the catalog IDs of the displayed notifications are recorded in history file 114.

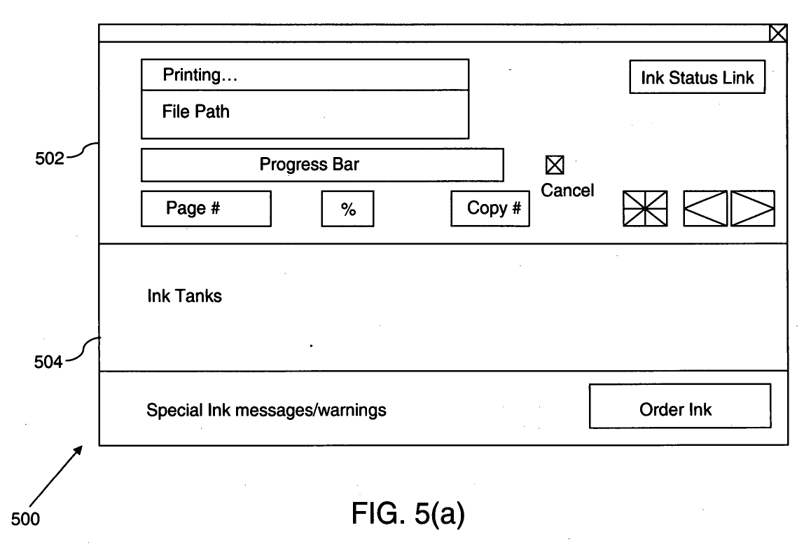

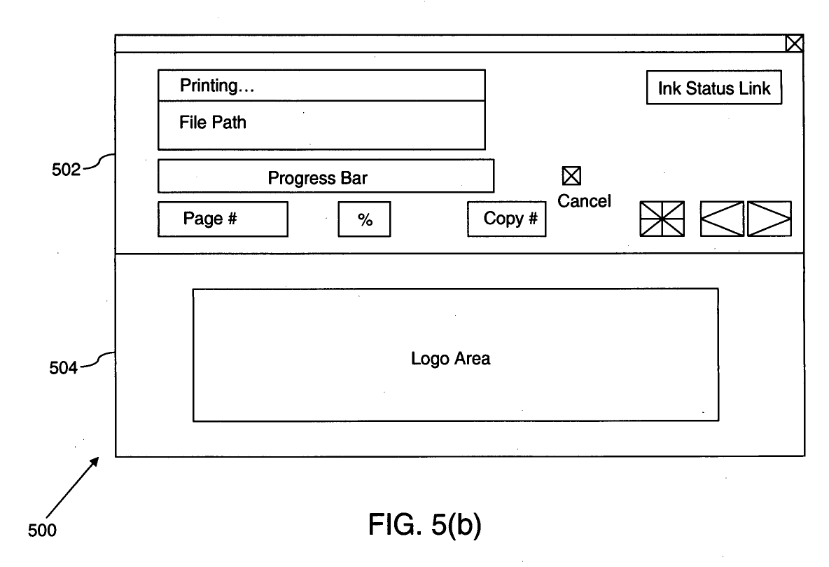

FIGS. 5(a) and 5(b) depict exemplary user interfaces 500 containing the notification for image forming device 100, e.g., a printer, in accordance with an embodiment of the invention. User interface 500 includes a status area 502 and a notification area 504. Status area 502 displays the status of processing of the job or document, for example, in an embodiment of the invention, status area 502 displays the printing status of the document. Status area 502 can also display the number of pages being printed, the status of the job in percentage form and in the form of a progress bar. In another embodiment of the invention, status area 502 can also provide one or more buttons to a user. The buttons are used to cancel the processing of a job or document.

Notification area 504 displays the notifications to the user. In an embodiment of the invention, notification area 504 displays notifications or messages related to the status of image forming device 100 and the resources used by image forming device 100. For example, notification area 504 displays messages related to the ink level. In another embodiment of the invention, notification area 504 displays notifications or messages to improve the output quality of image forming device 100. For example, if a user prints a colored photograph and the default print options are set for black-and-white printing in a printer that uses both black-and-white as well as colored cartridges, then notification area 504 will display a notification informing the user of the capability to print the photograph by using the colored cartridge. The following exemplary notification can be displayed:

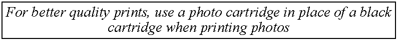

Notification area 504 can also notify the user to change the output format of the documents in order to improve the appearance and readability of the documents. In another embodiment of the invention, notification area 504 displays notifications suggesting that a user can use image forming device 100 to print additional information related to the document being printed. For example, if a user is printing a document on a date within a predefined period of time before a holiday, notification area 504 can display notifications (or billboards) to send holiday cards to friends and family. An exemplary rule, implemented using the following code, can be selected for evaluation:
<?xml version=“1.0” encoding=“iso-8859-1” ?>

<xsl:stylesheet version=“1.0” xmlns:xsl=“http://www.w3.org/1999/XSL/Transform”>

<xsl:output method=“text”/>

<xsl:template match=“/data”>

```
<xsl:if test=“./Month = 2 and ./Day >=1 and ./Day <14”>VALENTINES</xsl:if>
<xsl:if test=“./Month >=1 and ./Day >=23 and ./Month <=2 and ./Day
    <=7”>CHINESENY</xsl:if>
<xsl:if test=“./Month = 5 and ./Day >=2 and ./Day <=11”>MOTHERSDAY</xsl:if>
<xsl:if test=“./Month = 6 and ./Day >=10 and ./Day <=20”>FATHERSDAY</xsl:if>
<xsl:if test=“./Month = 12”>WINTERHOLIDAYS</xsl:if>
<xsl:if test=“./Month = 9 and ./Day >=2 and ./Day
    <=13”>GRANDPARENTSDAY</xsl:if>
<xsl:if test=“./Month = 10 and ./Day >=20 and ./Day <=31”>HALLOWEEN</xsl:if>
<xsl:if test=“./Month = 11 and ./Day >=18 and ./Day <=27”>THANKSGIVNG</xsl:if>
<xsl:if test=“./Month = 3 and ./Day <=11 and ./Day <=17”>STPATRICKSDAY</xsl:if>
<xsl:if test=“./Month = 12 and ./Day >=26 and ./Day <=31”>NEWYEARSDAY</xsl:if>
<xsl:if test=“./Month = 7 and ./Day >=1 and ./Day <=4”>INDEPENDENCEDAY</xsl:if>
    </xsl:template>
    </xsl:stylesheet>
```

The evaluation of the rule above will generate a particular identification value, depending on the current date. Based on the identification value, a particular holiday card billboard will be selected. For example, if the identification value ‘VALENTINES’ is selected, a corresponding billboard will be generated by using the following code:

<?xml version=“1.0” encoding=“iso-8859-1”?>
<?xml-stylesheet type=“text/xsl” href=“bb.xsl”?>
<html>
<head>
<title>Test XSLT</title>
<link rel=“stylesheet” href=“bb.css” type=“text/css”>
</link>
<script language=“JScript”><!--
function doAction( )
{ parent.CommonJS.BBAction(‘LAUNCH_URL’, 0); }
--></script>
</head>
<body class=“BBFrame PinkBG NoPadLeft”>
<br/>
<table cellpadding=“0” cellspacing=“0”><tr><td class=“DYKLayout”>
<img src=“images/valentinesdaybb.jpg”/>
</td><td>
<Text>PJValentine</Text>
</td></tr></table>
</body>
</html>

In yet another embodiment of the invention, notification area 504 displays default notifications or messages. For example, the default notification displays the logo or symbol of the company manufacturing image forming device 100 being used. In an embodiment of the invention, notification area 504 can include one or more buttons for viewing, accepting or rejecting the notifications displayed to the user. It is understood that notification area 504 may be displayed prior to image forming device 100 performing a printing operation so that the user may have an opportunity to modify the printing operation based upon the information provided in notification area 504.

In an embodiment of the invention, one or more components of notification system 104, such as catalog 112 and history file 114, can be updated. The updating of the components of notification system 104 includes updating the contents of the components. The updating of the components of notification system 104 is performed after a fixed time period. In an embodiment of the invention, the period after which updates need to be performed is specified by a user. For example, the user specifies that the updates need to be performed every five days. In another embodiment of the invention, the updates are performed after a default or pre-set time period without any user intervention.

To perform the updates, it is first determined whether the period after which the updates need to be performed has elapsed. In case the time to perform the updates has not reached, the components of notification system 104 continue to perform the desired functionalities without any updates. However, in case the time to perform the updates is achieved, the availability of the update packages is checked. In an embodiment of the invention, the update packages are software utilities or programs. In another embodiment of the invention, a single update package that contains update packages for all the components of notification system 104 is used. If the update packages are not available, the components of notification system 104 continue to perform the desired functions without any updates. However, if the update packages are available, the update packages are downloaded. In an embodiment of the invention, the update packages are downloaded from a network such as the Internet. In another embodiment of the invention, the update packages are stored and downloaded from a local server shared by one or more users.

Finally, the update packages are applied to one or more components of notification system 104. For example, the update packages are applied to catalog 112 and history file 114. The update packages are applied to catalog 112 to update the stored notifications with the addition of new notifications or the deletion of existing notifications. History file 114 is reset or removed with the application of the update packages. In an embodiment of the invention, the update packages are applied to the rules file to update the set of rules. In another embodiment of the invention, the update packages are applied to the rules index to update the order of the evaluation of the rules. In yet another embodiment of the invention, the update packages are applied to the notifications. The content, such as the images, text and sounds of the notifications, is updated with the application of the update packages.

The method and system described above improve the output quality of image forming devices by providing alternative ways or methods of producing the desired output to the user. The system also generates notifications suggesting that a user can use the image forming device to print additional information related to the document being printed. Further, the method and system provide suggestions and/or additional functionalities to optimize the use of resources such as paper, ink, toner, and the like. Moreover, the system takes inputs from the user environment and adapts accordingly to produce the desired output. In one example, the system can produce an output, based on the location of the user. For example, a notification can display a link to software within a specific date range which provides an ability to print holiday cards for mailing to friends and family. The dates of holidays can vary around different geographical locations. The same notification can then be used in different geographical locations by customizing the dates according to the user's location. Therefore, the system described above is user-friendly, provides opportunities for increased user interaction, and maximizes utilization of the image forming device. Further, the system updates the notifications frequently to eliminate outdated and repetitive notifications.

The notification system for generating one or more notifications for improving output quality of an image forming device, as described above with respect to various embodiments of the present invention or any of its components, may be embodied in the form of a computer readable program code for a computer system. Typical examples of a computer system includes a general-purpose computer, a programmed microprocessor, a micro-controller, a peripheral integrated circuit element, and other devices or arrangements of devices that are capable of implementing the functions and operations described above.

Such a computer system comprises a computer, an input device and a display unit. The computer may include a microprocessor and memory, both volatile and non-volatile. The computer system may further include a storage device such as a disk drive (hard disk drive, optical disk drive or solid state drive). The storage device can also be other similar means for loading computer programs or other instructions into the computer system. The computer system may also include a communication unit for accessing other databases and the Internet through an I/O interface. The communication unit may allow the transmission as well as reception of data from other databases. The communication unit may include a modem, an Ethernet card, or any other device which enables the computer system to connect to databases and networks such as LAN, MAN, WAN and the Internet. The computer system may facilitate inputs from a user through input device, accessible to the system through the I/O interface.

The computer system executes a set of instructions that are stored in one or more computer usable mediums, in order to process input data. The storage elements may also hold data or other information as desired. The storage element may be in the form of an information source or a physical memory element present in the processing machine.

The set of instructions may include various commands that instruct the computer system to perform the specific tasks and operations described above. The set of instructions may be in the form of a software program. Further, the software may be in the form of a collection of separate programs, a program module with a larger program or a portion of a program module. The software may also include modular programming in the form of object-oriented programming. The processing of input data by the processing machine may be in response to user commands, results of previous processing or a request made by another processing machine.

The foregoing description of several methods and embodiments of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An image forming device comprising:
a processing system for processing one or more documents, the processing system processing the one or more documents for image formation;
a notification system for generating one or more notifications, the one or more notifications being generated based on properties of the one or more documents identified during the processing, wherein the one or more notifications are used for improving quality of image formation; and
a display system for displaying the one or more notifications to a user.

2. The image forming device according to claim 1, wherein the notification system comprises a catalog for storing a plurality of indices, the plurality of indices comprising a plurality of identification values and at least one notification corresponding to each of the plurality of identification values, wherein the plurality of indices are used for generating the one or more notifications.

3. The image forming device according to claim 1, wherein the notification system comprises an evaluation module for evaluating one or more rules based on the properties of the one or more documents, wherein the one or more rules are evaluated for generating the one or more notifications.

4. The image forming device according to claim 3, wherein the notification system further comprises an input determination module for determining one or more input variables, the one or more input variables being determined based on the properties of the one or more documents, wherein the one or more input variables are used for the evaluation of the one or more rules.

5. The image forming device according to claim 1, wherein the notification system comprises a history file for maintaining a record of one or more notifications displayed in the past, wherein the history file is updated with the one or more notifications being displayed to the user.

6. The image forming device according to claim 1, wherein the one or more notifications provide additional information related to the one or more documents.

7. A notification system to be used by an image forming device, the notification system being used for improving output quality of the image forming device, the image forming device processing one or more documents for image formation, the notification system comprising:
an identification module for identifying one or more rules from a set of rules, wherein the identification module identifies the one or more rules based on a predefined order;
an evaluation module for evaluating the one or more rules based on the properties of the one or more documents, wherein the evaluation module determines an identification value;
a comparison module for comparing the identification value with a plurality of identification values, the plurality of identification values being stored in a plurality of indices, the plurality of indices comprising at least one notification corresponding to each of the plurality of identification values; and
a notification selection module for selecting one or more notifications from an index having an identification value corresponding to the identification value determined during the evaluation, wherein the one or more notifications correspond to one or more methods of improving the output quality of the image forming device.

8. The notification system according to claim 7 further comprising a catalog for storing the plurality of indices.

9. The notification system according to claim 7 further comprising an input determination module for determining one or more input variables, the one or more input variables being determined based on the properties of the one or more documents, wherein the one or more input variables are used for the evaluation of the one or more rules.

10. The notification system according to claim 7 further comprising a display module for displaying the one or more notifications being selected.

11. The notification system according to claim 7, wherein the one or more notifications are displayed on an external display device.

12. The notification system according to claim 7 further comprising a frequency checking module for checking frequency of occurrence of the one or more notifications in a history file, the history file maintaining a record of one or more notifications displayed in the past.

13. The notification system according to claim 12 further comprising an updating module for updating the history file with the one or more notifications being selected.

14. A method for improving output quality of an image forming device, the image forming device processing one or more documents for image formation, the method comprising:
identifying one or more rules to be evaluated from a set of rules, the one or more rules being identified based on a predefined order;
evaluating the one or more rules based on the properties of the one or more documents, the evaluation being performed to determine an identification value;
comparing the identification value with a plurality of identification values, the plurality of identification values being stored in a plurality of indices, the plurality of indices comprising at least one notification corresponding to each of the plurality of identification values; and
displaying one or more notifications from an index having an identification value corresponding to the identification value determined during the evaluation, wherein the one or more notifications correspond to one or more methods of improving the output quality of the image forming device.

15. The method according to claim 14 further comprising determining one or more input variables, the one or more input variables being determined based on the properties of the one or more documents.

16. The method according to claim 15, wherein the evaluation of the one or more rules is based on the one or more input variables.

17. The method according to claim 14 further comprising checking the one or more notifications in a history file, the history file maintaining a record of one or more notifications displayed in the past.

18. The method according to claim 17 further comprising updating the history file with the one or more notifications being displayed.

19. A computer program product for use with a computer, the computer program product comprising a computer usable medium having a computer readable program code embodied therein for improving output quality of an image forming device, the image forming device processing one or more documents for image formation, the computer readable program code performing:
identifying one or more rules to be evaluated from a set of rules, the one or more rules being identified based on a predefined order;
evaluating the one or more rules based on the properties of the one or more documents, the evaluation being performed to determine an identification value;
comparing the identification value with a plurality of identification values, the plurality of identification values being stored in a plurality of indices, the plurality of indices comprising at least one notification corresponding to each of the plurality of identification values; and
displaying one or more notifications from an index having an identification value corresponding to the identification value determined during the evaluation, wherein the one or more notifications correspond to one or more methods of improving output quality of the image forming device.
